(19) United States
(12) Patent Application Publication
(10) Pub. No.: US 2010/0053126 A1
(43) Pub. Date: Mar. 4, 2010

(54) ELECTRON EMISSION DEVICE AND IMAGE DISPLAY PANEL USING THE SAME, AND IMAGE DISPLAY APPARATUS AND INFORMATION DISPLAY APPARATUS

(75) Inventors: Tamaki Kobayashi, Isehara-shi (JP); Shoji Nishida, Hiratsuka-shi (JP); Takuto Moriguchi, Chigasaki-shi (JP); Takeo Tsukamoto, Atsugi-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/549,456

(22) Filed: Aug. 28, 2009

(30) Foreign Application Priority Data
Sep. 3, 2008 (JP) 2008-225812
Aug. 6, 2009 (JP) 2009-183719

(51) Int. Cl. G09G 5/00; H01J 1/02; H01J 1/62

(52) U.S. Cl. 345/204; 313/310; 313/235; 313/498; 345/74.1

(57) ABSTRACT

An electron emission device includes a polycrystalline film of lanthanum boride, and a size of a crystallite which composes the polycrystalline film is equal to or more than 2.5 nm and equal to or less than 100 nm, preferably the film thickness of the polycrystalline film is equal to or less than 100 nm.

### BACKGROUND OF THE INVENTION

1. Field of the Invention

The present invention relates to an electric field emission type electron emission device. The present invention also relates to an image display panel using the electron emission device, an image display apparatus which displays an image on the basis of an inputted image signal, and an information display apparatus which displays a signal included in an inputted information signal as an image.

2. Description of the Related Art

FIG. 10 is a typical cross-sectional view of a conventional general electric field emission type electron emission device. A cathode electrode 2 is provided on a substrate 1, and a conductive member 3 that is a conically-shaped projection is provided on the cathode electrode 2. A gate electrode 5 is provided via the cathode electrode 2 and an insulating layer 4, and is provided so as to surround the conductive member 3. A voltage is applied between the cathode electrode 2 and the gate electrode 5; and accordingly, an electron is emitted from the conductive member 3. As the electric field emission type electron emission device, an MIM type electron emission device, and a BSD type electron emission device, are included.

A rear plate in which such many electric field emission type electron emission devices are arranged on the substrate and a face plate in which a luminescent material such as a phosphor is disposed are arranged in face to face relation, and a surrounding area thereof is sealed; and accordingly, an airtight vessel (image display panel) can be formed. Then, a drive circuit is connected to an image display panel; and accordingly, an image display apparatus which displays an image is formed.

Japanese Patent Application Laid-Open No. S51-021471 and Japanese Patent Application Laid-Open No. 01-235124 disclose that an electric field emission type electron emission device has a conductive member that is a conically-shaped projection whose surface is coated with a material having a low work function and a high melting point.

V. Craciun et al., “Pulsed laser deposition of crystalline LaB₆ thin films,” Applied Surface Science, 247, 2005, pp. 384 to 389, and Dattatray. J. Late et al., “Field emission studies of pulsed laser deposited LaB₆ films on W and Re”, ultramicroscopy, 107, 2007, pp. 825 to 832, disclose lanthanum hexaboride as a low work function material.

### SUMMARY OF THE INVENTION

An electric field emission type electron emission device for use in an image display apparatus is required to achieve prolonged stable electron emission at a lower-operation voltage and at a lower degree of vacuum (higher pressure).

Even if the surface of the conductive member is coated by the low work function material as disclosed in Japanese Patent Application Laid-Open No. S51-021471, driving at an initial low voltage often cannot be performed with an elapse of time and an emission current often becomes unstable.

In addition, in the case where such an airtight vessel is formed, frequent heating process and cooling process (including natural cooling) are sometimes repeated, and influence due to this temperature change needs to be suppressed.

The present invention is implemented to solve the problem, and the present invention provides an electron emission device which includes a polycrystalline film of lanthanum boride and the size of crystallite that constitutes the polycrystalline film is equal to or more than 2.5 nm and equal to or less than 100 nm.

According to the present invention, fluctuation in emission current can be reduced. In addition, a work function can be equal to or less than 3.0 eV; and therefore, a driving voltage can be reduced. Further, even going through a manufacturing process of an electron emission device, the occurrence of peel-off or the like can be suppressed.

Further features of the present invention will become apparent from the following description of exemplary embodiments with reference to the attached drawings.

### BRIEF DESCRIPTION OF THE DRAWINGS

FIG. 1 is a typical cross-sectional view of an example of an embodiment of an electron emission device;

FIG. 2 is a typical view of an example in the case of driving the electron emission device;

FIG. 3 is a typical view showing a configuration of a polycrystalline film of lanthanum boride;

FIGS. 4A to 4C are typical views of another example of an embodiment of an electron emission device;

FIG. 5 is a typical plan, view showing an example of an electron source;

FIG. 6 is a typical cross-sectional view showing an example of an image display panel;

FIG. 7 is a block diagram showing an example of an image display apparatus and an information display apparatus;

FIGS. 8A to 8F are typical views showing an example of a manufacturing process of an electron emission device;

FIGS. 9A to 9C are typical views of another example of an embodiment of an electron emission device; and

FIG. 10 is a typical cross-sectional view of a conventional electron emission device.

### DESCRIPTION OF THE EMBODIMENTS

Hereinafter, an electron emission device and an image display apparatus according to the present embodiment will be described in detail with reference to drawings.

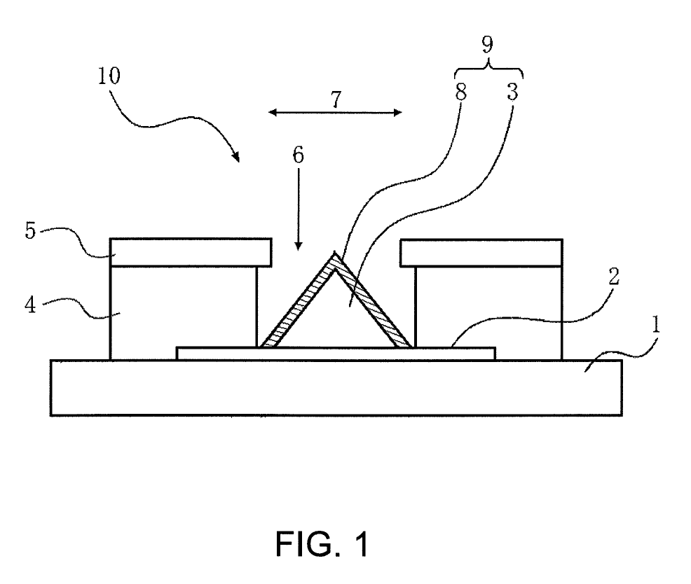

FIG. 1 shows a typical cross-sectional view of an example of an electron emission device 10 of the present embodiment.

A cathode electrode 2 is provided on a substrate 1, and a conductive member 3 which is electrically connected to the cathode electrode 2 is provided on the cathode electrode 2. The cathode electrode 2 has a function which regulates a potential of the conductive member 3 and supplies an electron to the conductive member 3. The resistance layer may be further provided between the cathode electrode 2 and the conductive member 3. In the embodiment shown in FIG, 1, the conductive member 3 is a conically-shaped projection; however, the conductive member 3 may be configured as long as including a projection portion (or sharp portion).

A gate electrode 5 is provided on the substrate 1 via an insulating layer 4. An opening 7 called gate hole, is provided through the insulating layer 4 and the gate electrode 5 formed on the insulating layer 4. The conductive member 3 is disposed in the opening 7. Preferably, the opening 7 is circular form; however, the opening 7 may be formed in a polygonal shape. Then, a surface of the conductive member 3 is coated with a polycrystalline film 8 of lanthanum boride. This case shows an embodiment in which the whole of the surface of the conductive member 3 is covered with the polycrystalline film 8; however, the polycrystalline film 8 of lanthanum boride may cover at least a part of the surface of the projection portion of the conductive member 3. Specifically, covering an end of the projection portion, or covering the nearest part of the projection portion to the gate electrode 5 is preferable. In the case where the conductive member 3 is circular cone, at least the tip portion of the circular cone may desirably be covered with the polycrystalline film 8. The conductive member 3 can be made of any of metal, metallic compound, and semiconductor. This case shows an example in which the cathode electrode 2 and the conductive member 3 are configured by different members; however, the conductive member 3 may be formed as a part of the cathode electrode 2. For example, a projection portion is formed on the cathode electrode 2, and the projection portion can be coated with the polycrystalline film 8 of lanthanum boride.

In the present embodiment, a cathode 9 is constituted by the conductive member 3 and the polycrystalline film 8 of the lanthanum boride. The cathode 9 is an electron emission body. Shape of the cathode 9 reflects the projection portion of the conductive member 3; therefore cathode 9 can be considered as having a projection portion. Accordingly, the polycrystalline film 8 of the lanthanum boride constitutes, at least a part of the projection portion of the cathode 9. In particular, the polycrystalline film 8 of the lanthanum boride constitutes at: least a part of surface of the projection portion of the cathode 9. This case shows an example in which the conductive member 3 and the polycrystalline film 8 of the lanthanum boride constitute cathode 9; however, the projection portion of the cathode 9 may be totally formed by the polycrystalline film 8 of the lanthanum boride. Moreover, the cathode 9 may be totally formed by the polycrystalline film 8 of the lanthanum boride; or cathode 9 and cathode electrode 2 may be totally formed by the polycrystalline film 8 of the lanthanum boride. However, it is preferable that at least a part of surface of the projection portion of the conductive member 3 is covered by the polycrystalline film 8, by controlling shape of the projection portion of the cathode 9 with the use of the projection portion of the conductive member. At any case, the polycrystalline film 8 of the lanthanum boride constitutes at least a part of surface of the projection portion of the cathode 9.

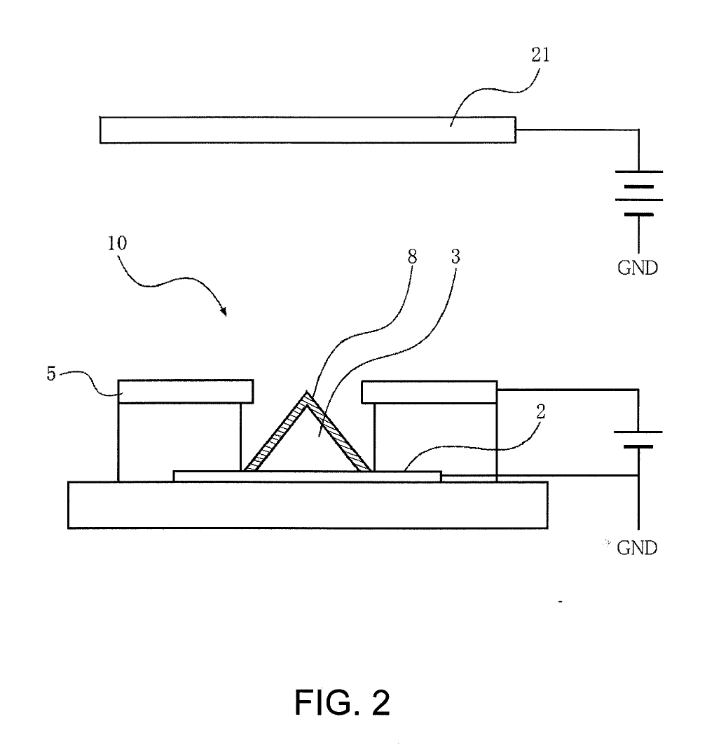

In the case of driving the electron emission device 10, as shown in FIG. 2, the electron emission device 10 is provided so as to opposite to an anode 21. The projection portion of the cathode 9 and an end of it are arranged toward the anode 21 in this way. And a pressure between the anode 21 and the electron emission device 10 is maintained to be lower than the atmospheric pressure (vacuum). Then, a potential of the gate electrode 5 is set to be higher than that of the cathode electrode 2. Those potentials forms electric field in a space 6 between the gate electrode 5 and the cathode 9, and an electron is emitted from the cathode 9 by the electric field. In addition, by setting a potential of the anode 21 to be sufficiently higher than that of the gate electrode 5, the electron emitted from the electron emission device 10 is accelerated toward the anode 21.

As described above, the electron emission device of the present embodiment is not, so-called, a hot cathode in which heating means is separately provided in the vicinity of the cathode to emit an electron by heating the cathode; but, is an electron emission device which uses, so-called, a cold cathode that emits an electron by electric field emission.

In addition, the description is made about the electron emission apparatus which is configured by the cathode electrode 2, the cathode 9, the gate electrode 5, and the anode 21. However, the electron emission apparatus which emits electron can be configured by applying a voltage between the anode 21 and the cathode 9, without providing a gate electrode 5.

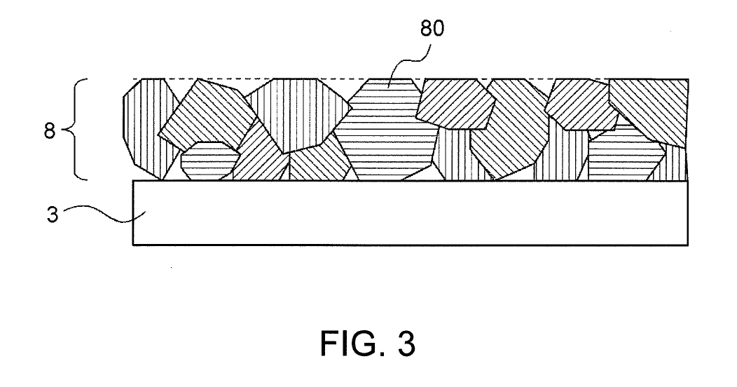

Next, the polycrystalline film 8 of lanthanum boride will be described. The polycrystalline film 8 of lanthanum boride has electric conductivity. The polycrystalline film 8 of lanthanum boride according to the present embodiment exhibits metallic conduction. As shown in FIG. 3, the polycrystalline film 8 of lanthanum boride according to the present embodiment has characteristics as, so-called, a polycrystal which is composed of many crystallites 80. Each crystallite 80 is made of lanthanum boride. The crystallite means a maximum group assumed as a single crystal. Incidentally, “grain” often indicates one composed of a plurality of crystallites, one which is amorphous granularity, and one which is granularity in appearance; that is, there are many cases where usage of the “grain” is not standardized as a term. The polycrystalline film 8 of the present invention is composed of, jointed (agglutinated) crystallites 80 or jointed (agglutinated) lumps of a plurality of crystallites; therefore the polycrystalline film shows electrically conductivity and composed as metallic film the polycrystalline film is different from so-called a fine particle film, which is composed of aggregation of particles (e.g. amorphous particles).

Although the crystallites 80 are jointed, or the plurality of the crystallite lumps (aggregate) are jointed, the polycrystalline film 8 according to the present invention sometimes has a pore between the crystallites 80 or between the plurality of the crystallite lumps aggregate. In addition, the polycrystalline film may have amorphous portion in some cases.

The size of the crystallite 80 which constitutes the polycrystalline film 8 of lanthanum boride according to the present embodiment is equal to or more than 2.5 nm. Then, film thickness of the polycrystalline film 8 is equal to or less than 100 nm. Therefore, an upper limit of the size of the crystallite 80 which constitutes the polycrystalline film 8 is inevitably 100 nm.

The crystallite size can be typically obtained from an X-ray diffraction measurement. The crystallite size can be calculated from a profile of diffraction line by a method referred to as Scherrer method.

The X-ray diffraction measurement can not only calculate the crystallite size, but also examine that the polycrystalline film 8 is configured by a polycrystal of lanthanum hexaboride and examine orientation. The lanthanum hexaboride (LaB₆) is a structure in which a ratio of La to B is represented by 1:6 as stoichiometric composition and has a simple cubic lattice. In this regard, however, as for a composition ratio, non-stoichiometric composition is also included and one whose grating constant is changed is also included.

In addition, as for measurement of a work function, a photoelectron spectroscopy method such as a vacuum UPS and a Kelvin probe method, and a method led by a relationship between electric field and current by measuring electric field emission current under vacuum are included; and the measurement can be obtained by combining these methods.

A material whose work function is known, for example, a metal film of approximately 20 nm such as Mo is formed on a surface of a projection portion of a conductive needle (e.g. tungsten needle) having a sharp projection portion, and electric field is applied under vacuum to measure electron emission characteristics. Then, an electric field multiplication coefficient depending on the shape of the projection portion that is the end of the needle, is obtained in advance from, the electron emission characteristics; after that, the polycrystalline film 8 of lanthanum boride is formed; and the work function can be obtained by calculation.

Fluctuation shows amplitude in temporal variation of the emission current. Temporal variation of the emission current can be obtained, for example, by periodically applying a rectangular waveform pulse voltage, and measuring the emission current. The fluctuation can be calculated by dividing deviation of the variation per unit time of the emission current by an average value of the emission current per unit time.

Specifically, a pulse voltage of a rectangular waveform having 6 msec in pulse width and 24 msec in cycle is continuously applied. Then, a sequence which measures an average of emission current values corresponding to the rectangular waveform pulse voltage for continuous 32 times is performed at an interval of 2 sec to obtain a deviation and an average value per 15 min. Incidentally, in the case of comparing amplitude of fluctuation between a plurality of electron emission devices, a crest value of the applying voltage is set so as to be substantially equal in the average value of current.

In this case, the description is made about an example of an electric field emission device which includes the cone-shaped conductive member 3 as the electron emission device. However, the electron emission device applicable for the present embodiment can preferably be applicable for an MIM type electron emission device and electric field emission devices which use a carbon fiber such as a carbon nanotube. That is, at least an electron emission portion, moreover, an electron emission body of those electron emission devices may be covered with the polycrystalline film 8.

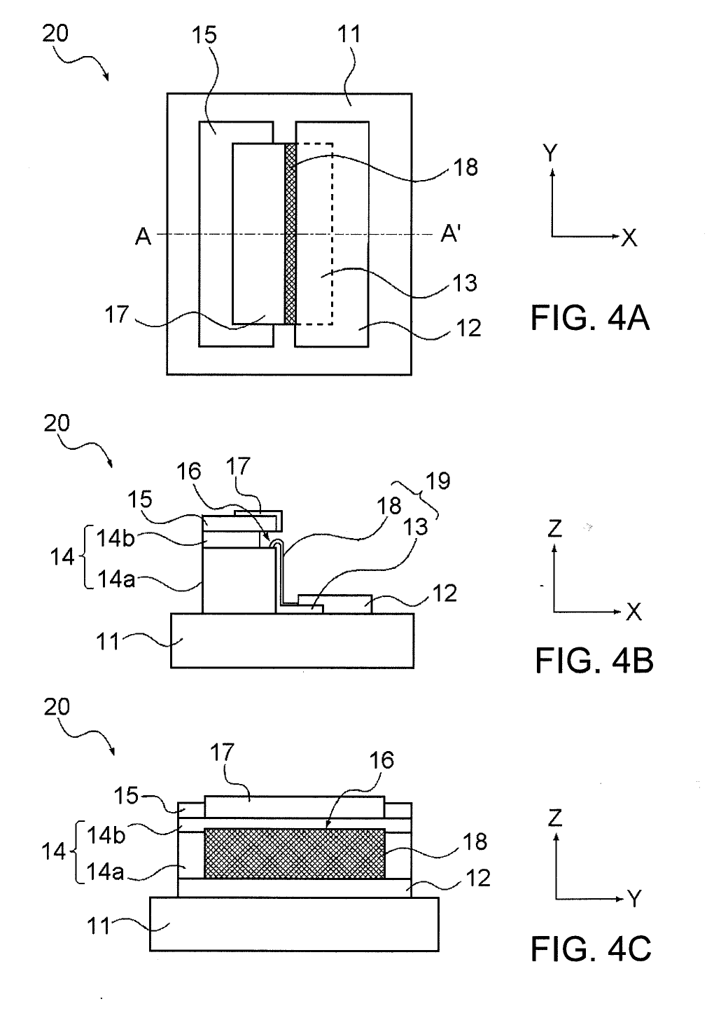

Next, a mode in the case where a polycrystalline film of lanthanum boride of the present invention is applied to another electron emission device is exemplarily shown in FIGS. 4A, 4B, and 4C. FIG. 4A is a typical plan view seen from a Z direction; and FIG. 4B is a typical cross-sectional view (Z-X faces) taken along the line A-A′ shown in FIG. 4A. FIG. 4C is a typical view when seen from an X direction shown in FIG. 4B.

In an electron emission device 20, a gate electrode 15 is provided on a substrate 11 via an insulating layer 14. The insulating layer 14 include a first insulating layer 14a and a second insulating layer 14b. In addition, a cathode electrode 12 is provided on the substrate 11; and a conductive member 13 connected to the cathode electrode 12 is provided along a surface of the first insulating layer 14a. The second insulating layer 14b is smaller in width than the first insulating layer 14a in the X direction; and a recess 16 is provided between the insulating layer 14 (first insulating layer 14a) and the gate electrode 15. The conductive member 13 is provided as a conductive film. Then, as is apparent from FIG. 4B, the conductive member 13 is provided in the Z direction, projecting from the substrate 11. That is, the conductive member 13 includes a projection portion. In addition, a part, of the conductive member 13 is entered in the recess 16. As a result, it can be said that at least a part of the conductive member 13 includes the projection portion located in the recess 16.

Then, a polycrystalline film 18 of lanthanum boride is provided on a surface of the conductive member 13. This case shows an embodiment in which the most part of the conductive member 13 is covered with the polycrystalline film 18 of lanthanum boride. However, at least a part of the surface of the projection portion of the conductive member 13 may be covered with the polycrystalline film 18 of lanthanum boride. Specifically, covering an end of the projection portion, or covering the nearest part of the projection portion to the gate electrode 5 is preferable. That is to say, the polycrystalline film 18 of lanthanum boride may be provided so as to be located between the conductive member 13 and the gate electrode 15. The polycrystalline film 18 of lanthanum boride has the same feature as the polycrystalline film 8 of lanthanum boride described by using FIG. 1, FIG. 3, and the like.

A cathode 19 is constituted by the conductive member 13 and the polycrystalline film 18 in the electron emission device 20 of the embodiment described here, same as above mentioned embodiment. The cathode electrode 12 has a function which regulates a potential of the conductive member 13 and supplies an electron to the conductive member 13. The cathode 19 has a shape which reflects the shape of the projection portion of the conductive member 13; and therefore, it can be said that the cathode 19 includes a projection portion.

Consequently, the polycrystalline film 18 of the lanthanum boride constitutes at least a part of projection portion of the cathode 19. In particular, the polycrystalline film 18 of the lanthanum boride constitutes at least a part of surface of the projection portion of the cathode 19. This case shows an example in which the conductive member 13 and the polycrystalline film 18 of the lanthanum boride constitute cathode 19; however, the projection portion of the cathode 19 may be totally formed by the polycrystalline film 18 of the lanthanum boride. Moreover, the cathode 19 may be totally formed by the polycrystalline film 18 of the lanthanum boride; or cathode 19 and cathode electrode 12 may be totally formed by the polycrystalline film 8 of the lanthanum boride. The membranal cathode 19 can be used in this example; therefore shape of the projection portion of the cathode 19 can be preferably controlled by the polycrystalline film 18 of the lanthanum boride. In any case, the polycrystalline film 18 of lanthanum boride constitutes at least at a part of the projection portion of the cathode 19.

In addition, in FIGS. 4A and 4C, the conductive member 13 and the polycrystalline film 18 are continuously provided in the Y direction; however, the conductive member 13 and the polycrystalline film 18 can be configured at a plurality of positions while being spaced with a predetermined interval in the Y direction.

Besides, FIG. 4 shows an example in which a part of the gate electrode 15 is covered with a conductive film 17 that is made of the same material as the conductive member 13. The conductive film 17 can be omitted; however, the conductive film 17 may preferably be provided for forming stable electric field. The polycrystalline film of lanthanum boride may be provided on the conductive film 17 or the gate electrode 15.

According to this configuration, the gate electrode 15 and the cathode 19 are arranged with a gap in between. A potential higher than that of the cathode electrode 12 is applied to the gate electrode 15; and accordingly, electric field is formed at the gap and an electron can be emitted from the cathode 19. In an electron emission apparatus using the electron emission device in this embodiment, as in FIG. 2, an anode 21 is arranged at a position opposed, to the electron emission device 20. As a result, the projection portion of the cathode 19 and an end of it are arranged toward the anode.

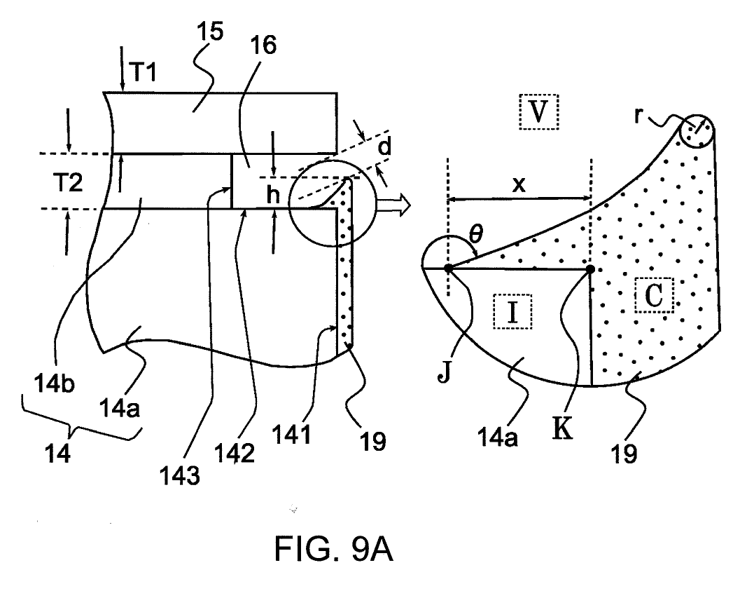

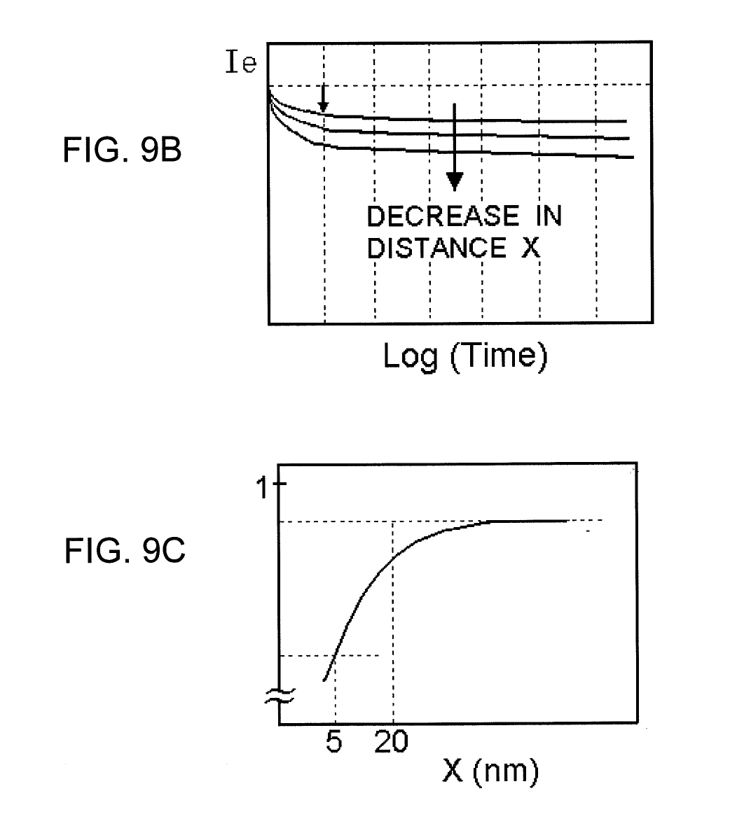

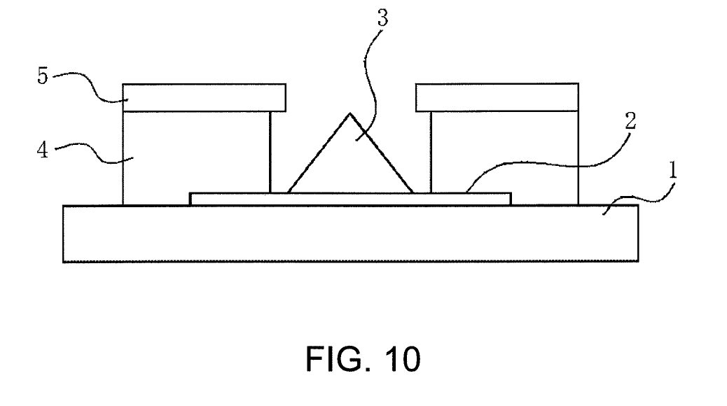

Next, the shape of the cathode 19 of the embodiment will be described using FIGS. 9A to 9C. FIG. 9A is a typical cross-sectional view which enlarges the projection portion of the cathode 19.

As described above, the cathode 19 may include the polycrystalline film 18 of the present invention at least at a part of the projection portion.

In addition, FIG. 9A shows an embodiment in which a part of the gate electrode 15 is not covered with the conductive film 17 in order to simply describe. However, even if the conductive film 17 covers the gate electrode 15, the conductive film 17 is substantially equipotential with the gate electrode 15; and therefore, the conductive film 17 may be assumed as a part of the gate electrode 15.

Hereinafter, surfaces of the insulating layer 14 composed of the first insulating layer 14a and the second insulating layer 14b will be described for each part using different representation. More specifically, the surface of the insulating layer 14 can be separated into side face 141 of the first insulating layer 14a, a top face 142 of the first insulating layer 14a, and side face 143 of the second insulating layer 14b. Of the surfaces of the first insulating layer 14a, the top face 142 of the first insulating layer 14a is a face which configures the recess 16. Of the surfaces of the first insulating layer 14a, the side face 141 of the first insulating layer 14a is a face continued to the top face 142 of the first insulating layer 14a. As described above, the first insulating layer 14a is a structure having a step. Then, the projection portion of the cathode 19 is formed in the vicinity of an inflection (point K) that is a border of the top face 142 and the side face 141. The side face 143 of the second insulating layer 14b is a face which configures the recess 16. The top face 142 and the side face 143 configures the recess 16, in this manner. The top face 142 of the first insulating layer 14a and the side face 143 of the second insulating layer 14b are faces inside the recess 16; and therefore, the top face 142 and the side face 143 can be represented as internal surfaces of the insulating layer 14. On the other hand, the side face 141 of the first insulating layer 14a is a face outside the recess 16; and therefore, the side face can be represented as external surface of the insulating layer 14.

Typically, the top face 142 of the first insulating layer 14a is substantially parallel to the surface of the substrate 11. On the other hand, FIG. 4 shows the embodiment in which the side face 141 of the first insulating layer 14a is perpendicular to the surface of the substrate 11, and the inflection of the first insulating layer 14a is a right angle. However, the side face 141 of the first insulating layer 14b may be inclined to the surface of the substrate 11. That is, the side face 141 may be configured as a slope face. More particularly, the side face 141 may preferably be inclined so as to make an acute, angle with respect to the surface of the substrate 11. In such a case of the side face 141 being the slope face, an inflection angle (an angle on the insulating layer side shown as “I” in FIG. 9A) of the first insulating layer 14a can be an obtuse angle. Incidentally, the above-mentioned words “acute angle” or “obtuse angle” does not mean mathematical accuracy, but the faces has curvature at some level.

The gate electrode 15 is provided spaced apart from the top face 142 of the first insulating layer 14a by a distance T2. The distance T2 corresponds to thickness of the second insulating layer 14b. That is, the second insulating layer 14b is a layer which is also for regulating an Interval between the top face 142 of the first insulating layer 14a and the gate electrode 15.

In the present embodiment, preferably, the projection portion of the cathode 19 is located across the top face 142 of the first insulating layer 14a and the side face 141 of the first insulating layer 14a. That is, a part of the projection portion of the cathode 19 is located in the recess 16, and may preferably be come in contact with, the top face 142 of the first insulating layer 14a. With this configuration, an interface is formed between the projection portion of the cathode 19 and the top face 142 of the first insulating layer 14a.

In FIG. 9A, a distance h (h>0) shows that the projection portion of the cathode 19 projects from the top face of the first insulating layer 14a by a height h. A portion that is the height h is the end of the projection portion. A distance x (x>0) is a width in a depth direction of the recess 16 at a boundary face between the projection portion of the cathode 19 and the top face of the first insulating layer 14a. In other words, the distance x is a distance from the edge (point J) of a projection portion coming into contact with the surface of the insulating layer 14 which constitute s the recess 16 to an edge of the recess 16, that is, to the inflection (point K) of the first, insulating layer 14a. Practically, although depending to the depth of the recess 16, the distance x is within a range of 10 nm to 100 nm.

With such a configuration, a contact area between the projection portion of the cathode 19 and the first insulating layer 14a increases, and a mechanical adhering force between the projection portion of the cathode 19 and the first insulating layer 14a improves. This can suppress the occurrence of peel-off or the like of the cathode 19 even going through a manufacturing process of the electron emission device.

With such a configuration, variation in emission current, can be suppressed. In this regard, description will be made in detail.

FIG. 9B shows the amount of time variation of Ie in the case of changing the distance x in the recess 16. Incidentally, Ie in this case denotes the amount of electron emission and the amount of electrons that reach the anode 21. The amount of average emitted electrons Ie detected for the first 10 sec after a driving of the electron emission device 20 is started, is obtained as an initial value. Then, standardization is made on the basis of the initial value, and change of the amount of electron emission is plotted as common logarithm. As understood from FIG. 9B, with a decrease in the distance x, the amount of reduction from the initial value of the amount of emitted electrons tends to increase.

FIG. 9C is one in which the same measurement as FIG. 9B is performed in some devices. In FIG. 9C, standardization is made on the basis of the initial, value of the amount of emitted electrons with respect to the distance x, and the amount of electron emission at a time when a predetermined time elapses after a driving of the electron emission device 20 is started is plotted. As is apparent from this drawing, the shorter the distance x is, the larger the amount of reduction from the initial value is. Then, when the distance x exceeds 20 nm, declining trend of dependent property with respect to the distance x is observed. As described above, preferably, the distance x is equal to or more than 20 nm.

Viewing from these results, the reason is presumably that the distance x increases in length, thereby increasing in the contact area between the projection portion and the first insulating layer 14a, whereby thermal resistance can be reduced. In addition, the reason is presumably that heat capacity due to an increase in volume of the projection portion of the cathode 19 increases. That is, a rise in temperature of the cathode 19 is presumably reduced; and therefore, early variation seems to be reduced.

On the other hand, when the distance x is extremely increased, a leakage current between the cathode 19 and the gate electrode 15 increases via an internal surface of the recess, that is, via the top face of the first insulating layer 14a and the side face of the second insulating layer 14b. At least, preferably, the distance x is smaller than the depth of the recess 16.

In addition, preferably, an angle 9 made, by the surface of the cathode 19 (in particular, the edge (point J) of the cathode 19 located on the top face 142) and the top face 142 of the first insulating layer 14a is more than 90°. Furthermore, preferably, the angle θ is less than 180°. Incidentally, the angle θ is an angle on the vacuum side (shown as “V” in FIG. 9A) made by the surface of the cathode 19 and the top face 142 of the first insulating layer 14a. If the top face 142 is assumed as a flat face, a contact angle between the cathode 19 and the top face 142 is represented by 180°-θ. Practically, since the top face 142 of the insulating layer 14a is assumed as the flat face; in other words, the contact angle between the top face 142 and the cathode 19 may preferably be set to more than 0° and less than 90°.

Further, in the recess 16, the surface of the cathode 19 may preferably be gradually inclined with respect to the top face 142 of the first insulating layer 14a. That is, preferably, an angle between tangent line of the surface of an arbitrary portion located in the recess 16 of the cathode 19 and the top face 142 of the first insulating layer 14a is less than 90°.

This can suppress abnormal discharge occurred in the recess 16. Description will be made about this point in detail.

Generally, a point where three kinds of materials different in dielectric constant, such as vacuum, an insulator, and a conductor simultaneously come in contact with each other at one point is referred to as a triple junction.

Although depending on conditions, electric field of the triple junction becomes extremely higher than surroundings, thereby sometimes causing discharge. Also in the embodiment, the point J shown in FIG. 9A is the triple junction of vacuum (v), an insulator (I), and a conductor (C). If the angle θ in which the projection portion of the cathode 19 comes in contact with the first insulating layer 14a is equal to or more than 90°, the electric field at the triple junction is not so different from surrounding electric field. The projection portion of the cathode 19 becomes the angle θ; and accordingly, electric field strength at the triple junction occurred at the insulator-vacuum-conductor is weakened and it becomes possible to prevent a discharge phenomenon due to the occurrence of abnormal electric field.

The shortest distance d between the gate electrode 15 and the end of the projection portion of the cathode 19 is shown in FIG. 97A. In this example, the distance d is also the shortest distance between the gate electrode 15 and the cathode 19. In addition, a shape near the end of the projection portion shown in FIG. 9A can be represented by a curvature radius r.

In the case where a potential difference between the gate electrode 15 and the cathode 19 is constant, the strength of electric field formed in the vicinity of the end portion differs in response to the curvature radius r and the distance d. The smaller the r is, the stronger the electric field can be formed in the vicinity of the end portion. Further, the smaller the d is, the stronger the electric field can be formed in the vicinity of the end portion.

In the case where the electric field near the end of the projection portion is constant, if the distance d is relatively small, the curvature radius r can be relatively large. Conversely, if the curvature radius r is relatively small, the distance d can be relatively large. A difference in the distance d influences on a difference in the number of scatterings of emitted electron; and therefore, the smaller the r is and the larger the d is, the higher the efficiency of the electron emission device 20 can be obtained. In this case, a current (If) detected when a voltage is applied to the device and a current (Ie) taken out under vacuum are used; and accordingly, efficiency (η) is given as efficiency η=Ie/(If+Ie).

An example of a method of manufacturing the electron emission device 20 will be described.

As the substrate 11, quartz glass, glass in which the content of impurity such as Na is reduced, soda lime glass, and a silicon substrate can be used. As functions necessary for the substrate, not only those having high mechanical strength, but also those having resistance to alkali and acid such as dry etching, wet etching, or developing solution, and those small in difference in thermal expansion as compared with a deposition material and other laminating member in the case of using as one body such as a display panel may desirably be used. Furthermore, a material which is difficult to diffuse an alkali element from the inside of the glass with an implementation of heat treatment may desirably be used.

First, in order to form a step on a substrate, a first insulating layer 14a and a second insulating layer 14b are sequentially formed. A gate electrode 15 is laminated on the second insulating layer 14b.

The first insulating layer 14a is an insulative film made of a material excellent in workability, for example, silicon nitride and silicon oxide; and formation thereof is performed by a general vacuum deposition method such as a sputtering method, a CVD method, and a vacuum evaporation method. In addition, thickness thereof is set to a range of several nm to several tens μm; preferably, a range of several tens nm to several hundreds nm is selected.

The second insulating layer 14b is an insulative film made of a material excellent in workability, for example, silicon nitride and silicon oxide; and formation thereof is performed by a general vacuum deposition method, for example, the CVD method, the vacuum evaporation method, or the sputtering method. In addition, thickness T2 thereof is set to a range of several nm to several hundreds nm; preferably, a range of several nm to several tens nm is selected.

Although detail description will be made later, in order to accurately form a recess 16, the first insulating layer 14a and the second insulating layer 14b may preferably be different materials. Silicon nitride can be used as the first insulating layer 14a, and the second insulating layer 14 can be configured by, for example, silicon oxide, PSG high in phosphorus concentration, BSG high in boron concentration, or the like.

The gate electrode 15 has conductivity, and can be formed by the general vacuum deposition technique such as the evaporation method, or the sputtering method. Thickness T1 of the gate electrode 15 is set to a range of several nm to several hundreds nm and a range of several tens nm to several hundreds nm may preferably be selected.

A material of the gate electrode 15 has high thermal conductivity in addition to electronic conductivity, and a material high in melting point may desirably, be used. For example, a metal or an alloy material such as Be, Mg, Ti, Zr, Hf, V, Nb, Ta, Mo, W, Al, Cu, Ni, Cr, Au, Pt, or Pd can be used. In addition, a compound such as a nitride material, oxide material, or carbide material; a semiconductor; carbon; carbon compound; or the like can also be used.

Patterning of the first insulating layer 14a, the second insulating layer 14b, and the gate electrode 15 can be performed by using a photolithography technique and etching processing. As the etching processing, Reactive Ion Etching (RIE) can be used.

Next, the second insulating layer 14b is selectively etched; and accordingly, the recess 16 can be formed on the insulating layer 14 composed of the first insulating layer 14a and the second insulating layer 14b. Preferably, the ratio of the amount of etching between the first insulating layer 14a and the second insulating layer 14b is equal to or more than 10; and more preferably, equal to or more than 50.

As the selective etching, for example, if the second insulating layer 14b is silicon oxide, mixed solution of ammonium fluoride and hydrofluoric acid, referred to as buffer hydrofluoric acid (BHF) is used; and if the second insulating layer 14b is silicon nitride, thermo phosphoric acid system etching solution can be used.

The depth of the recess 16 (width of the exposed top face 142 of the first insulating layer 14a) is considerably related to a leakage current after element formation; and the deeper the recess 16 is formed, the smaller the leakage current becomes. However, if the recess 16 is so deeply formed, there arises a problem in that the gate electrode 15 deforms. Therefore, preferably, the depth of the recess 16 is 30 nm to 200 nm.

Selective etching by materials is not performed; but, a part of the side face of the insulating layer is masked and a part of the insulating layer is removed; and accordingly, the recess 16 can be formed. In that case, the first insulating layer 14a and the second insulating layer 14b do not need to form by different materials; but, formation may be made as the insulating layer of one layer. In addition, the insulating layer is composed of three layers, and selective etching may be performed to the second layer. In that case, the recess 16 is formed by the three insulating layers.

Next, a material of a conductive member 13 is made to deposit to a top face and a side face of the first, insulating layer 14a. As for the material of the conductive member 13, a material high in melting point and a material having high thermal conductivity in addition to conductivity may preferably be used. In addition, a material equal to or less than 5 eV in work function may preferably be used. For example, a metal or an alloy material such as Be, Mg, Ti, Zr, Hf, V, Nb, Ta, Mo, W, Al, Cu, Ni, Cr, Au, Pt, Pd, or the like can be used. Furthermore, a compound such as a nitride material, oxide material, carbide material, or the like; a semiconductor; carbon; carbon compound; or the like can also be appropriately used. More particularly, Mo or W may preferably be used.

The conductive member 13 can be formed by the general vacuum deposition technique such as the evaporation method, or the sputtering method. As described above, in the present embodiment, formation needs to be carried out by controlling an incident angle and a deposition time of the conductive material, and a temperature at a time of formation and the degree of vacuum at a time of formation so as to control the shape of the projection portion of the cathode. The incident angle of the conductive material can be determined by taking into account of the thickness T1 of the gate electrode 15, the interval T2 of the recess 16, or the like.

Next, a polycrystalline film 18 of lanthanum boride of the present invention is formed on the surface of the conductive member 13. The polycrystalline film 18 of the lanthanum boride can be formed by the sputtering method, as to be described later.

A cathode electrode 12 can be formed by using the general vacuum deposition technique such as the evaporation method, or the sputtering method; or, the formation can be made by sintering a precursor including a conductive material. As a pattern formation method, a photolithography technique and a printing technique can be used.

A material of the cathode electrode 12 may use any material as long as the material has conductivity, and the material which is the same as the gate electrode 15 can be used. The thickness of the cathode electrode 12 is set to a range of several tens nm to several μm; and a range of several tens nm to several hundreds nm may preferably selected. Incidentally, the cathode electrode 12 may be provided before forming the conductive member 13, or may be provided after forming the conductive member 13 or the polycrystalline film 18.

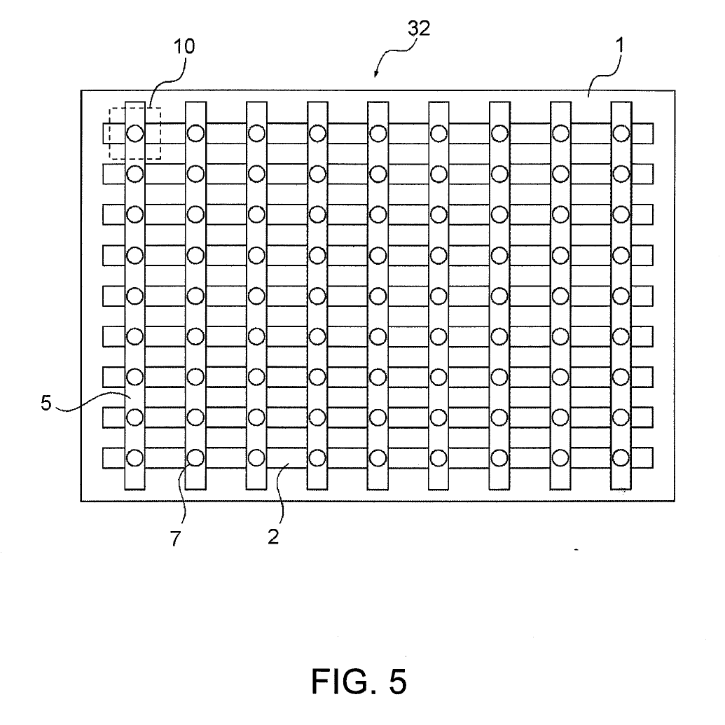

Next, an example of an electron source 32 which is configured by arranging many electron emission devices 10 of the embodiment on a substrate 1 will be described by using FIG. 5. FIG. 5 is a typical plan view of an electron source 32.

The electron source 32 described here is configured by the substrate 1 and a plurality of electron emission devices 10 formed on the substrate 1. The substrate 1 can be configured by an insulative substrate; for example, a glass substrate may preferably be applicable. The electron source 32 is configured by arranging many electron emission devices 10, which are described using FIG. 1 and the like, in a matrix form on the substrate 1. The electron emission devices 10 of the same column are connected to a common gate electrode 5, and the electron emission devices 10 of the same row are connected to a common cathode electrode 2. In place of the electron emission device 10, the electron emission device 20 described using FIG. 4 can also be used.

The predetermined number is selected from the plurality of cathode electrodes 2, the predetermined number is selected from the plurality of gate electrodes 5, and a voltage is applied between the selected electrodes; and accordingly, electron can be emitted from the predetermined electron emission device 10.

In this case, one electron emission device 10 is provided at an intersected portion of one cathode electrode 2 and one gate electrode 5; however, a plurality of electron emission devices 10 may preferably be provided. For example, a plurality of openings 7 are provided at respective intersected portions of the cathode electrodes 2 and the gate electrodes 5; and the cathode 9 is provided in each of the openings 7.

FIG. 5 simply shows an example in which one opening 7 is provided at each intersected portion of the cathode electrode 2 and the gate electrode 5. However, from, the viewpoint of reducing fluctuation in emission current, the more the number of cathodes 9 provided at each intersected portion is, the more preferable the configuration is. The reason is that, if the number of the cathodes 9 is large, fluctuation in emission current is averaged. On the other hand, provision of too many cathodes is not desirable from the viewpoint of productivity. The fluctuation in current can be reduced by using the polycrystalline film of the present invention; and therefore, the fluctuation in current can be reduced without increasing the number of the cathodes 9.

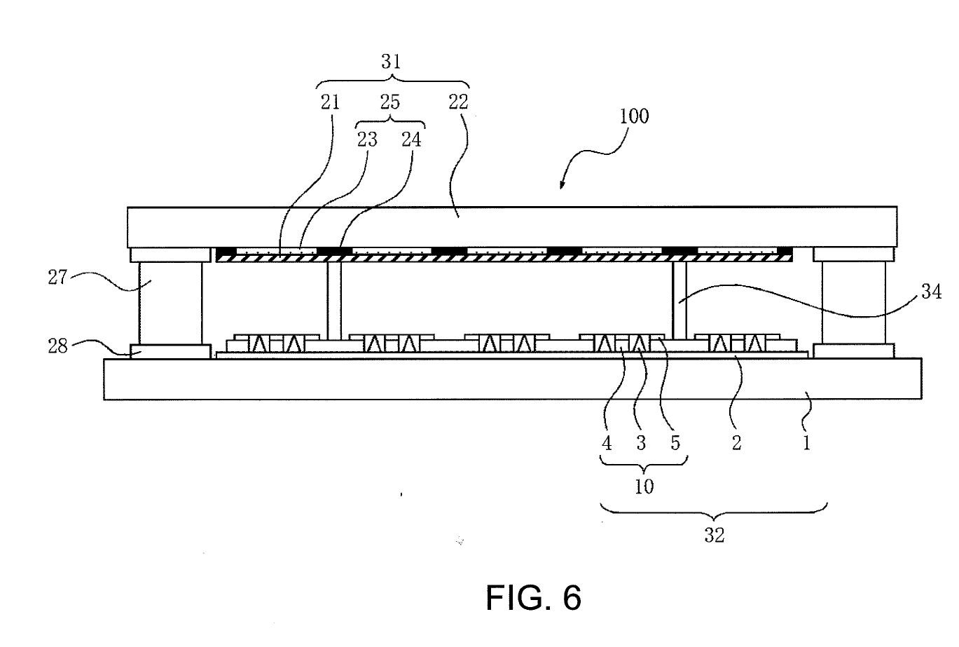

An example in which an image display panel 100 is configured by means of the electron source 32 will be described using FIG. 6. In the example shown in this case, a cathode 9 provided at each intersected portion is prepared in plural.

Incidentally, the image display panel 100 is held in air tightness so that the inside becomes a pressure lower than the atmospheric pressure (vacuum); and therefore, rewording can be made to an airtight vessel.

FIG. 6 is a typical cross-sectional view of the image display panel 100. The image display panel 100 uses the electron source 32 shown in FIG. 5 as a rear plate; and a rear plate 32 and a face plate 31 are arranged in face-to-face relation.

Then, a ring-closing (rectangular shape) supporting frame 27 is provided between the rear plate 32 and the face plate 31 so that an interval between the rear plate 32 and the face plate 31 becomes a predetermined distance. A joint member 28 equipped with a sealing function such as indium and frit glass joints between the supporting frame 27 and the face plate 31 and between the supporting frame 27 and the rear plate 32 in air tightness. The supporting frame 27 also serves as a role which is for sealing an internal space of the image display panel 100 in air tightness. A spacer 34 may preferably be arranged in plural between the face plate 31 and the rear plate 32 inside the image display panel 100 so as to maintain a distance between the face plate 31 and the rear plate 32 in the case where an area of the image display panel 100 is large.

The face plate 31 is configured by a luminescent layer 25 equipped with a luminescent material 23 which emits light by being irradiated by an electron emitted from an electron emission device 10, an anode electrode 21 provided on the luminescent layer 25, and a transparent substrate 22.

The transparent substrate 22 is made of, for example, a glass substrate because light emitted from the luminescent layer 25 needs to be transmitted through.

As a luminescent material 23, a phosphor can generally be used. The luminescent layer 25 is configured by using a luminescent material which emits light of red, a luminescent material which emits light of green, and a luminescent material which emits light of blue; and accordingly, the image display panel 100 of a full color display can be configured. In an embodiment shown in FIG. 6, the luminescent layer 25 includes a black member 24 provided between luminescent materials. The black member 24 is a member which is for improving contrast of a display image, generally referred to as a black matrix.

The electron emission device 10 which irradiates an electron to each luminescent material 23 is provided so as to opposite to the luminescent material 23. That is, each electron emission device 10 responds to one luminescent material 23.

The anode electrode 21 is generally referred to as a metal back, typically, can be configured by an aluminum film. In addition, the anode electrode 21 can be provided between the luminescent layer 25 and the transparent substrate 22. In that case, the anode electrode 21 is configured by an optically transparent conductive film such as an ITO film.

In a process (joint process) which is for jointing the face plate 31 and the rear plate 32 in air tightness is often performed under heated conditions where members which constitute the image display panel 100 serving as an airtight vessel.

The joint process, typically arranges the supporting frame 27 provided with a joint member such as frit glass between the face plate 31 and the rear plate 32. Then, the joint process is performed by heating the face plate 31, the rear plate 32, and the supporting frame 27 at a range of 100° C. to 400° C. while pressurizing; followed by cooling to the room temperature. In addition, in advance to the joint process, the rear plate 32 is often treated by degassing treatment or the like by heating. Even going through processes accompanied with such heating and cooling, the polycrystalline film of lanthanum boride shown in the present embodiment is not peeled from the conductive member 3.

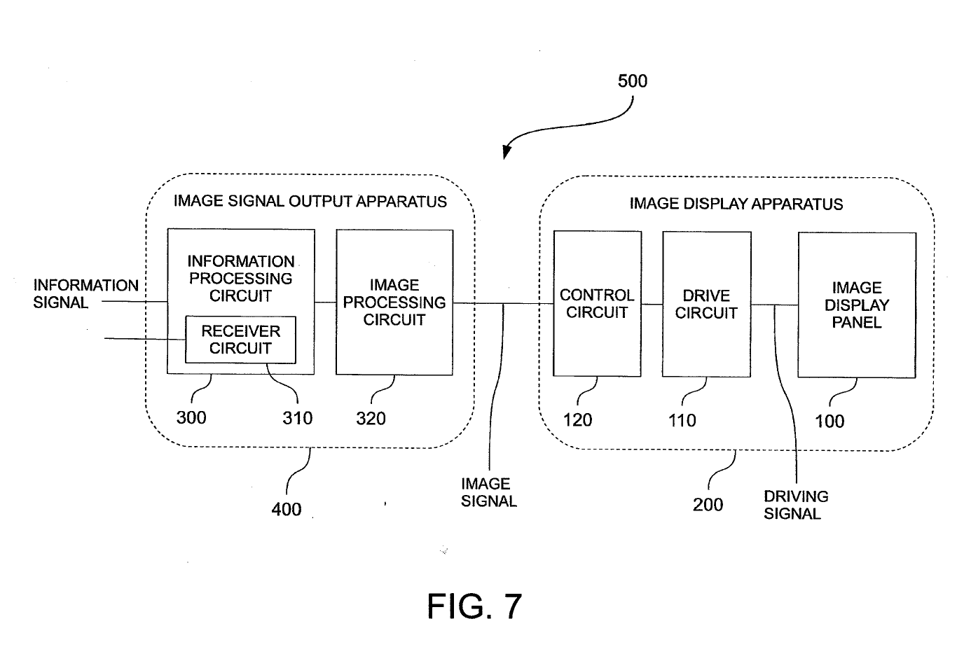

In addition, even in the case where the image display panel 100 is similarly manufactured by means of the electron emission device 20, although going through processes accompanied with heating and cooling, the polycrystalline film 18 of lanthanum boride is not peeled and the conductive member 13 is not peeled. Next, as shown in FIG. 7, a drive circuit 110 which is for driving an image display panel is connected to the image display panel 100; and accordingly, a image display apparatus 200 can be made. Further, an image signal output apparatus 400 which outputs an information signal such as a television broadcasting signal, and a signal recorded in an information recording apparatus as an image signal is further connected; and accordingly, an information display apparatus 500 can be configured.

The image display apparatus 200 includes at least the image display panel 100 and the drive circuit 110, and a control circuit 120 may preferably be included. The control circuit 120 treats signal processing of correction processing or the like suitable for an image display panel to the inputted image signal, and outputs the image signal and various kinds of control signals to the drive circuit 110. The drive circuit 110 outputs a driving signal to each interconnection, (see the cathode electrode 2 and the gate electrode 5 shown in FIG. 5) of the image display panel 100 on the basis of the inputted image signal. The drive circuit has a modulation circuit which is for converting the image signal to the driving signal and a scanning circuit which is for selecting the interconnection. A voltage to be applied to the electron emission device of each pixel in the image display panel 100 is controlled by the driving signal outputted from the drive circuit 110. With this, each pixel emits light at luminance corresponding to the image signal, and image is displayed on a screen. It may be said that “screen” corresponds to the luminescent layer 25 in the image display panel 100 shown in FIG. 4.

According to the present invention, a polycrystalline film low in work function is used in an electron emission device, thereby allowing to reduce an applied voltage necessary for electron emission (driving of electron emission device), whereby electric power consumption of an image display apparatus can be reduced. In addition, a stable emission current can be obtained; and accordingly, quality of a display image can be improved.

FIG. 7 is a block diagram showing an example of an information display apparatus. The information display apparatus 500 includes an image signal output apparatus 400 and an image display apparatus 200. The image signal output, apparatus 400 includes an information processing circuit 300, and an image processing circuit 320 may preferably be included. The image signal output apparatus 400 may be incorporated in a housing different from the image display apparatus 200, or at least a part of the image signal output apparatus 400 may be incorporated in the same housing as the image display apparatus 200. A configuration of the information display apparatus described in this case is an example, and various modifications can be made.

An information signal such as a television broadcasting signal of terrestrial and satellite broadcasts, and a data broadcasting signal or the like via an electric communication circuit such as the Internet connected by a radio network, a telephone network, a digital network, an analog network, and TCP/IP protocol is inputted to an information processing circuit 300. A configuration in which a storage device such as a semiconductor memory, an optical disk, or a magnetic storage devices connected and an information signal recorded in such a storage device can be displayed on the image display panel 100 can be made. In addition, a configuration in which a video input apparatus such as a video camera, a still camera, or a scanner is connected and an image obtained from such a video input apparatus can be displayed on the image display panel 100 can be made. A configuration can be made so as to connect a teleconference system and a system such as computers.

Further, it is possible to configure such that an image to be displayed on the image display panel 100 is processed if required and is output ted by a printer, and it is also possible to configure so as to record in a storage device.

Information included in the information signal indicates at least one of video information, character information, and audio information. The information processing circuit 300 can include a receiver circuit 310 which is equipped with a tuner that selects necessary information from a broadcasting signal and a decoder which decodes an information signal in the case where the information signal is encoded.

The image signal obtained by the information processing circuit 300 is outputted to the image processing circuit 320. The image processing circuit 320 can include a circuit which provides various treatments to the image signal. For example, a gamma correction circuit, a resolution conversion circuit, and an interface circuit can be included. Then, an image signal converted to a signal format of the image display apparatus 200 is outputted to the image display apparatus 200.

A method which outputs video information or character information to the image display panel 100 and displays on the screen can be performed as follows: for example, an image signal corresponding to each pixel of the image display panel 100 is generated from the video information and the character information of the information signals inputted to the information processing circuit 300. Then, the generated image signal is inputted to the control circuit 120 of the image display apparatus 200. Then, on the basis of the image signal inputted to the drive circuit 110, a voltage to be applied from the drive circuit 110 to each electron emission device in the image display panel 100 is controlled and an image is displayed. An audio signal is outputted to audio reproducing means (not shown) such as a differently provided speaker, is made in synchronization with the video information and the character information to be displayed on the image display panel 100, and is reproduced.

### EXAMPLE

Hereinafter, the present invention will further be described in detail by giving Examples.

### Example 1

A polycrystalline film of lanthanum boride was formed by a sputtering method. At that time, samples of conditions A to D shown in Table 1 were prepared by changing preparation conditions so as to differentiate film quality and film thickness. An Si wafer was used as a substrate.

The film thickness was measured by means, of a stylus-type step measuring apparatus under the conditions of Table 1. In addition, crystallite sizes were obtained by a Scherrer method by means of an X-ray diffraction method. Measurement conditions of X-ray diffraction was a thin film method; an incident angle was 0.5° and an X-ray source was CuKα. Calculation was made by means of a (100) diffraction peak of cubical crystal LaB₆. Incidentally, the conditions A to C were those in which Ar pressure at a time of DC sputtering was changed, and the condition D was made by an RF sputtering method.
Condition A:
   pressure at a time of deposition; 0.3 Pa
   power supply and power; DC900 W
Condition B:
   pressure at a time of deposition; 2.0 Pa
   power supply and power; DC900 W
Condition C:
   pressure at a time of deposition; 12.0 Pa
   power supply and power; DC900 W
Condition D:
   pressure at a time of deposition; 6.7 Pa
   power supply and power; RF800 W

TABLE 1

| | Condition | | | Condition |
|---|---|---|---|---|
| | A | Condition B | Condition C | D |
| Film thickness (nm) | 100 | 100 | 100 | 100 |
| Crystallite size (nm) | 3.1 | 9.5 | 14.1 | 16.1 |
| Ratio of B when | 6.7 | 6.2 | 6.1 | −6.0 |
| La is set to 1 | | | | |

As shown in Table 1, the crystallite size can be changed depending on sputtering conditions. Although it cannot completely be described depending on a configuration of a sputtering apparatus, for example, distance between a substrate and a target, and the size of the target; there appeared a tendency that the lower the Ar pressure at a time of sputtering was, the smaller the crystallite size was.

Even any of the films formed by conditions A to D, a film was not peeled; however, in the case of depositing a film thicker than 100 nm and, more specifically, in the case of extending the deposition time, there was sometimes film peel-off. In addition, even when tried to increase the thickness more than 100 nm by increasing a power level, there was sometimes film peel-off. Incidentally, this peel-off occurred not only at a time of deposition, but also sometimes after several hours to several days. In addition, patterning was performed; and therefore, there appeared sometimes peel-off in the act of a photolithographic process such as resist coating, development, and peel-off. When a temperature raising process is added, this peel-off phenomenon became prominent. From this reason, it may be said that the film thickness of the polycrystalline film of lanthanum, boride may preferably be equal to or less than 100 nm. In the case where the film thickness is more than 100 nm, there is sometimes film peel-off; and reliability as the electron emission device is sometimes damaged. Therefore, as a result, an upper limit of the crystallite size is also 100 nm.

There is a case where a diffraction peak showing crystallinity in X-ray diffraction cannot be detected depending on the sputtering conditions; and such case seems to be an amorphous embodiment. Such an amorphous film (it can be described as a film which is extremely small in crystallite size) was appeared in the case of conditions extremely low in power. In addition, even when an electron beam evaporation method (EB) was used as a film formation method, an amorphous film was formed. In this case, energy necessary for crystal growth cannot be obtained because an evaporation molecule or atom energy is low; and as a result, amorphous seems to be formed.

When conditions in which crystallinity was confirmed (including the conditions A to D) about a composition ratio of La and B were obtained by an ICP method, the ratio of B when La was set to 1 vias 6.0 to 6.7. The larger the crystallite size is, the smaller the ratio of B is; that is, there is a trend toward near 6; and from this phenomenon, the presumption is made that there appears mutual relation between nearing to stoichiometric composition and increasing in crystallite size.

From this reason, the amorphous film seems to be lacking in energy necessary for crystal growth, or seems to be an unstable state in which the crystallinity cannot be maintained because the composition ratio of La to B largely deviates from 6.0. In the amorphous film, although to be described later, a work function increases more than 3.0 eV, and characteristics largely different from the polycrystalline film. This means that to have a crystalline structure of LaB₆ is important for actualizing a work function equal to or less than 3.0 eV.

Next, samples of conditions E to H and a Comparative Example A shown in Table 2 were prepared.

An Si wafer was used for a substrate, and confirmation of crystallinity by film thickness and X-ray diffraction was performed. In addition, for the purpose of examining electron emission characteristics at the same time, a polycrystalline film of lanthanum boride was also coated to one in which a molybdenum film of 20 nm was formed on a needle made of tungsten, the needle having the end (projection portion) whose curvature radius was approximately 100 nm. Hereinafter, the tungsten needle is referred to as W-needle with Mo ground.

This W-needle with Mo ground was examined that no abnormality was found by confirming the shape by SEM in advance. Incidentally, when an electric field multiplication coefficient was calculated in advance from the electron emission characteristics from the W-needle with Mo ground, so called, by performing F-N (Fowler-Mordheim) plotting, 5.8×10³ (cm⁻¹) was obtained as an Mo work function was 4.6 eV. Incidentally, measurement of the electron emission characteristics was performed by arranging a tabular anode being spaced apart from the end of the W-needle with Mo ground by 3 mm under ultra high vacuum equal to or less than 1×10⁻⁸ Pa. Then, a DC voltage was applied to an anode; and a current flowing into the anode due to electric field emission was measured.

Next, film formation conditions will be described.

Conditions E to H are those which are formed by DC sputtering, the condition E is one in which a film thickness is 30 nm by adjusting a deposition time at the same pressure and power as the condition A. Similarly, the condition F is one in which a film thickness of the condition B is 30 nm; the condition. G is one in which a film thickness of the condition C is 30 nm; and the conditions H is one in which a film thickness of the condition D is 30 nm.

The Comparative Example A was formed by conditions of an amorphous film and, more specifically, by an electron beam evaporation method. As for the film of the Comparative Example A, a peak showing crystallinity was not observed by X-ray diffraction.

TABLE 2

| | Condition | Condition | Condition | Condition | Comparative |
|---|---|---|---|---|---|
| | E | F | G | H | Example |
| Film | 30 | 30 | 30 | 30 | 30 |
| thickness | | | | | |
| (nm) | | | | | |
| Crystallite | 3.0 | 8.0 | 12.0 | 14.0 | Amorphous |
| size (nm) | | | | | |
| Work | 2.6 | 2.8 | 2.7 | 2.7 | 3.8 |
| function | | | | | |
| (eV) | | | | | |
| Fluctua- | 15.7% | 10.0% | 7.8% | 5.0% | Not |
| tion | | | | | evaluated |

In Table 2, the crystallite size shows that one formed on an Si substrate is obtained by the X-ray diffraction method. As for an LaB₆ film formed on the W-needle with Mo ground, observation by a cross-section TEM is performed, and an image of an ordered lattice showing crystallinity is confirmed. A size thereof is, for example, an average approximately 3 nm in the condition E; and is a well coincided result with a crystallite size which is formed on the Si substrate and obtained by the X-ray diffraction method.

When observation is performed by the cross-section TEM, a plurality of lattice fringes appeared to be substantially disposed in parallel are confirmed in a region corresponding to crystallite. Then, the mutually most separate two grid fringes are selected from, the plurality of grid fringes, and the length of the longest line segment of line segments connecting the end of one grid fringe and the end of the other grid fringe can be certified as the crystallite size (crystallite diameter). Then, if a plurality of crystallites are confirmed in the region observed by the cross-section TEM, an average value of those crystallite sizes may be set as the crystallite size of the polycrystalline film of lanthanum boride.

A work function was obtained for films of the conditions E to H formed on the W-needle with Mo ground and the Comparative Example A by arranging a tabular anode being spaced apart from the needle end by 3 mm under super high vacuum equal to or less than 1×10⁻⁸ Pa. A DC voltage was applied to the anode; and a current flowing in to the anode due to electric field emission was measured. The DC voltage was gradually increased, and accordingly the current flew rapidly; however, this voltage (threshold voltage) was a lower voltage as compared with the case of only the W-needle with Mo ground in any of the conditions E to H and the Comparative Example A. Table 2 shows a relationship between the voltage and the current, more specifically, the value of calculated work function obtained from inclination of F-N plotting, as the Mo work function being 4.6 eV. From the work function in Table 2, it shows that an extremely low work function, which is equal to or less than 3.0 eV in the conditions E to H in which the crystallite size is equal to or more than 3.0 nm, except for the Comparative Example A with a noncrystalline film, can be actualized. As described above, in the Comparative Example A which is an amorphous film, the cause in which the work function of 3.8 eV is higher as compared with E to H of the polycrystalline film seems that a crystalline structure of LaB₆ cannot be established. In the Comparative Example A, electron emission is extremely unstable and, more specifically, variation in threshold voltage of the electron emission. was appeared.

With reference to fluctuation in emission current, measurement conditions will be described below.

An apparatus for use in evaluation is the same as one used for calculation of the work function. As an object to be evaluated, in this case, one in which an LaB₆ film corresponding to the conditions E to H was formed on the W-needle with Mo ground to serve as a cathode and a tabular anode being spaced apart from the end by 3 mm were arranged was used. Then, a pulsing DC voltage (rectangular wave voltage) was applied to the anode; and a current flowing into the anode due to electric field emission was measured. More specifically, a pulse voltage having a rectangular waveform which is 6 msec in pulse width and 24 msec in cycle is applied. Then, a sequence for measuring an average of emission current values corresponding to a rectangular waveform pulse voltage for continuous 32 times was performed at an interval of 2 sec, and a deviation and an average value per 15 min were obtained; and accordingly, fluctuation shown in Equation (1) was calculated.

Fluctuation=deviation per 15 min/average value per 15 min Equation (1)

Table 2 shows fluctuation values corresponding to the conditions E to H. Incidentally, the fluctuation values were obtained by adjusting a crest value of a rectangular waveform pulse voltage to be applied so as to be substantially 1 μA in average value of current to be measured. Table 2 shows that amplitude of fluctuation has a mutual relation with crystallite size; and in the same film thickness, the larger the crystallite size is, the smaller the fluctuation is. The reason is presumed that proportion taken up per unit volume of a gap between crystal grain boundaries or crystals is reduced due to an increase in crystallite size, and influence on a change in work function in the vicinity of an electron emission portion due to diffusion of impurity or the like is reduced. In the polycrystalline film of lanthanum boride whose crystallite size is up to 100 nm, although depending on the crystallite size with respect to the film thickness, the same good electron emission characteristics can be obtained.

With reference to the fluctuation, in the case where the current value was more than 1 μA, a trend toward a decrease in fluctuation to be calculated was appeared. Conversely, in the case where the current value was smaller than 1 μA, a trend toward an increase in fluctuation to be calculated was appeared.

Further, when a driving for 10 hours was performed at a rectangular waveform pulse voltage in which the fluctuation was calculated in the conditions E to H, deterioration and raise of the current value were hardly appeared and the fact of having stable driving stability was confirmed.

As described above, in the electron emission device of the present Example equipped with the polycrystalline film of lanthanum boride, stable electron emission which is small in work function and small in fluctuation can be actualized.

### Example 2

Samples of conditions I to K shown in Table 3 were prepared by changing deposition conditions so as to differentiate film quality and film thickness of a polycrystalline film of lanthanum boride.

In the case of forming the samples, the polycrystalline film of lanthanum boride was formed on an Si wafer at the same time. Measurement of film thickness and crystallite size were required by means of the film on the wafer. Further, for the purpose of examining electron emission characteristics, the polycrystalline film of lanthanum boride was also formed on a W-needle with Mo ground. This W-needle with Mo ground was examined that no abnormality was found by confirming the shape by SEM in advance. When an electric field multiplication coefficient was calculated in advance from the electron emission characteristics from the W-needle with Mo ground, so called, by performing F-N (Fowler-Nordheim) plotting, 5.8×10³ (cm⁻¹) was obtained as an Mo work function was 4.6 eV.

First, formation conditions of the polycrystalline film of lanthanum boride will be described.

Conditions I is one which is formed by the same sputtering apparatus as the conditions A to H described in the Example 1, and the conditions J and K are formed by means of a sputtering apparatus different therefrom. Therefore, deposition conditions cannot be simply compared. The conditions J and K are formed by changing a deposition time. Incidentally, the conditions J and K are 0.77 W/cm² in power density. Further, a distance between a target and sample is arranged so as to be 95 mm.
Condition I:
   pressure at a time of deposition; 2.0 Pa
   power supply and power; RF800 W
Condition J:
   pressure at a time of deposition; 1.5 Pa
   power supply and power; RF250 W
Condition K:
   pressure at a time of deposition; 1.5 Pa
   power supply and power; RF250 W

TABLE 3

| | Condition I | Condition J | Condition K |
|---|---|---|---|
| Film thickness (nm) | 7 | 10 | 20 |
| Crystallite size (nm) | 2.5 | 7.0 | 10.7 |
| Integrated intensity | 0.54 | 1.3 | 2.8 |
| ratio I(100)/I(110) of | | | |
| (100) to (110) | | | |
| Work function (eV) | 2.85 | 2.85 | 2.8 |
| Fluctuation | 6.7% | 7.4% | 7.7% |

In Table 3, the film thickness was measured by means of a stylus-type step measuring apparatus. In addition, the crystallite size was obtained by an X-ray diffraction method and by a Scherrer method. As for the measurement condition of X-ray diffraction, the conditions J and K used a thin film method, an incident angle was 0.5°, and an X-ray source was CuKα. The condition I used an In-plane method. The crystallite size was calculated by means of a (100) plane diffraction peak of cubical crystal LaB₆ cubical crystal LaB₆. In addition, for the purpose of examining orientation of a crystal direction of a polycrystalline film 8, an integrated intensity ratio I₍₁₀₀₎/I₍₁₁₀₎, of integrated intensity I₍₁₀₀₎ of a diffraction peak represented by (100) plane and integrated intensity I₍₁₁₀₎ of a diffraction peak represented by (110) plane, was obtained. A peak showing crystallinity was observed for any of the films of the conditions I to K, confirmation was made that the film was a polycrystalline film, and the crystallite size was equal to or more than 2.5 nm. In the condition I, the integrated intensity ratio I₍₁₀₀₎/I₍₁₁₀₎ was 0.54. When this was compared by JCPDS (Joint Committee on Power Diffraction Standards), good coincidence with values (JCPDS#34-0427) observed when orientation was not appeared was shown. From this reason, it may be said that the film of the condition I is a non-orientation film whose crystal, orientation is random. On the other hand, in the conditions J and K, the integrated intensity ratio I₍₁₀₀₎/I₍₁₁₀₎ is more than 0.54 and is strong in orientation of (100) plane. As compared with the condition J, an integrated intensity ratio becomes larger in the condition K which is thicker in film thickness; and accordingly, it shows that the thicker the film thickness is, the more advanced the orientation in plane direction corresponding to a diffraction peak represented by (100) plane is. In the film thickness more than 20 nm and equal to or more than 30 nm, I₍₁₀₀₎/I₍₁₁₀₎ was more than 2.8. In equal to or less than 20 nm, integrated intensity in plane direction other than (100) plane and (110) plane each was lower than integrated intensity in plane direction of (100) plane and (110) plane. Furthermore, the crystallite size which is thicker in film thickness becomes large.

As for films of the conditions I to K formed on the W-needle with Mo ground, a tabular anode is arranged being spaced apart from the needle end by 3 mm under super high vacuum equal to or less than 1×10⁻⁸ Pa. Then, a DC voltage was applied to the anode; and a current flowing into the anode due to electric field emission was measured; and accordingly, a work function was obtained. Table 3 shows values in which, as the Mo work function being 4.6 eV, by a relationship between the voltage and the current, more specifically, by performing the F-N plotting, the work function was calculated from inclination thereof. As shown in Table 3, any of the conditions I to K has a work function equal to or less than 3.0 eV, and has excellent electron emission characteristics.

In addition, as for fluctuation, measurement is performed by means of an evaluation method described in the Example 1, and the result is shown in Table 3. Any of the conditions I to K has a small fluctuation. In the condition I, the fluctuation is small in spite that the crystallite size is small; and the reason is presumed that the film thickness is small with respect to the size of crystallite, or the film does not have orientation and the film is non-orientation.

As described above, the film thickness of the polycrystalline film equal to or more than 2.5 nm in crystallite size of lanthanum boride is set to equal to or less than 20 nm; and accordingly, both the work function and the fluctuation can be extremely stable and small; and therefore, such a configuration is particularly preferable. Furthermore, in a polycrystalline film of which thickness is equal to or less than 20 nm and size of a crystallite of the lanthanum boride is equal to or more than 2.5 nm, it is particularly preferable that ratio I₍₁₀₀₎/I₍₁₁₀₎ is equal to or more than 0.54 and equal to or less than 2.8, thereby reducing both of the work function and the fluctuation with outstanding stability.

As described above, in the case where the film thickness is thicker than 100 nm, there is sometimes film peel-off; and therefore, such a configuration is not preferable. Even when patterning of the polycrystalline film of lanthanum boride is performed by dry etching or wet etching, the film thickness is preferable to be thin from the stand point of shortening of a processing time and processing accuracy. In addition, in a range equal to or less than 20 nm in film thickness, the peel-off is not occurred even via a heating process of approximately 500° C. Also in t his regard, good electron emission characteristics can be actualized by the film thickness equal to or less than 20 nm; and therefore, such a configuration is preferable. Further, in the case of forming a shape having a sharp end, if the forming film thickness is thick, there is concern that the degree of sharpness of the end becomes dull; and therefore, the thinner the film thickness the lore preferable.

### Example 3

In this example, samples of conditions L and M, in which the deposition conditions of the Example 2 is used so as to make film thickness of a polycrystalline film exceeds 20 nm, are prepared. In the condition L, deposition is executed to form a film having 20 nm thickness in the condition K, and to form 10 nm film over it in the condition J, thereby a polycrystalline film of which thickness is 30 nm is formed. An integrated intensity ratio of an area within 10 nm thickness from surface of the polycrystalline film formed in this condition L can be estimated, in simply, from a difference between the integrated intensity of this film and the integrated intensity of the film formed in the condition J. It is observed that, the integrated intensity ratio estimated by this method is less than 2.8 of the condition K. The integrated intensity ratio can be also calculated by adjusting the incident angle of X-ray less than 0.5°. And, this polycrystalline film showed smaller fluctuation of the emission current than the polycrystalline film having 20 nm thickness and formed in the condition K, although not smaller than the condition J.

In the condition M, an amorphous film having 30 nm thickness is deposited in the comparative example A, and a film is deposited over it in the condition I, thereby a film having 37 nm thickness is formed. An integrated intensity ratio of an area within 7 nm thickness from surface of the film formed in this condition M showed good correspondence with the result of X-ray diffraction in the condition I, wherein the ratio is estimated from a difference between the integrated intensity of this film and the integrated intensity of the film formed in the comparative example A.

The work function and the fluctuation appear to be controlled by surface and adjacent structure of an electron emission body. Accordingly, considering in conjunction with the result of the Example 2, the polycrystalline film having crystallite size equal to or more than 2.5 nm, and having a layer from surface to 20 nm depth, or, from surface to less depth than 20 nm, wherein a characteristic of the layer is same as the polycrystalline film of the Example 2, can actualize low work function and low fluctuation. In other words, the preferable integrated intensity ratio I₍₁₀₀₎/I₍₁₁₀₎ in an area having depth equal to or less than 20 nm from surface of the polycrystalline film is equal to or more than 0.54 and equal to or less than 2.8.

The crystallite size is equal to or more than 2.5 nm in this area, obviously. In such polycrystalline film, the work function and the fluctuation can be reduced with outstanding stability like as a polycrystalline film having thickness less than 20 nm, even if the thickness of the polycrystalline film exceeds 20 nm.

### Example 4

The electron emission device 10 in which the film of the conditions I to K having characteristics shown in Example 2 is formed as the polycrystalline film 8 on the circular cone conductive member 3 shown in FIG. 1 was prepared, and electron emission measurement was performed by driving as shown in FIG. 2. Incidentally, 100 electron emission devices were formed on the substrate 1.

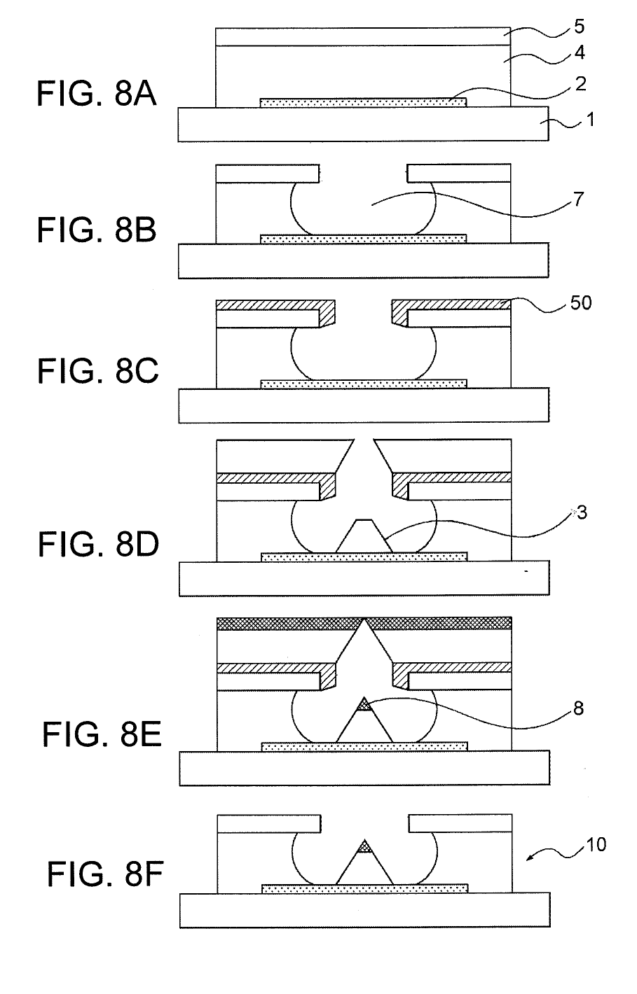

Hereinafter, a method of manufacturing an electron emission device will be described using FIGS. 8A to 8F. Incidentally, in this case, a polycrystalline film 8 of lanthanum boride was formed only on a projection portion (end) of a circular cone conductive member 3.
(Process 1) A cathode electrode 2 was formed on a glass substrate 1 by patterning after forming a Cr layer on the substrate 1 by a sputtering method. After that, an SiO₂ layer 4 was formed as an insulating layer on the cathode electrode 2 by a CVD method; and further, a Cr layer 5 serving as a gate electrode was formed on the insulating layer 4 by the sputtering method (FIG. 8A).
(Process 2) After a circular opening was formed on the Cr layer 5 serving as a gate electrode by photolithography and wet etching, a gate hole (opening) 7 was formed by performing wet etching of the SiO₂ layer 4 using the Cr layer 5 as a mask (FIG. 8B). Incidentally, 100 openings 7 were formed in a grid-like pattern so as to be 10 units vertically by 10 units horizontally. The wet etching of the SiO₂ layer 4 was performed till the cathode electrode 2 was exposed.
(Process 3) An Al layer 50 serving as a peel-off layer was formed on the Cr layer 5 by omniazimuthally oblique evaporation (FIG. 8C).
(Process 4) Mo was deposited on the substrate from a direction perpendicular to the substrate by the sputtering method. With this method, the substantially conically-shaped conductive member 3 made of Mo was obtained on the cathode electrode 2 (FIG. 8D).
(Process 5) Sputtering was performed toward the inside of the gate hole 7 by using lanthanum hexaboride as a target. With this method, the polycrystalline film 8 of lanthanum boride was formed on the end (projection portion) of the substantially conically-shaped conductive member 3 made of Mo (FIG. 8E).
(Process 6) Finally, the Al layer serving as the peel-off layer was selectively performing wet etching; and accordingly, Mo on the Al layer and the polycrystalline film of lanthanum boride on the Al layer were removed. The electron emission device was formed by the processes (FIG. 8F).

A voltage is applied between the cathode electrode 2 and the gate electrode 5 of the thus formed electron emission device as shown in FIG. 2; and accordingly, 100 devices can be operated.

In addition, an electron emission device 10 is held in a vacuum vessel (not shown) together with the anode 21; and the electron emission device 10 is connected to a power supply which is for applying a voltage between the cathode electrode 2 and the gate electrode 5 via a current introduction terminal and to a power supply which is for applying a voltage to the anode 21. Incidentally, a shunt resistor (not shown) is inserted between the anode 21 and the power supply which is for applying a voltage thereto, and a difference in voltage across the ends of the shunt, resistor is measured; and accordingly, a current flowing due to electron emission can be measured. The inside of the vacuum vessel is held at a pressure equal to or less than 1×10⁻⁸ Pa by exhausting by an ion pump. The anode 21 is arranged spaced apart from the electron emission device 10 by a distance of 3 mm.

Incidentally, the power supply which is for applying a voltage between the cathode electrode 2 and the gate electrode 5 can apply a pulsing voltage (rectangular wave voltage) and, more specifically, a rectangular waveform pulse voltage which is 6 msec in pulse width and 24 msec in cycle is applied; and accordingly, electric field necessary for electron emission is formed. In a state where a voltage of 1 kV was applied to the anode 21, the rectangular waveform pulse voltage was applied between the cathode electrode 2 and the gate electrode 5. Then, a sequence for measuring an average of current emitted in response to a rectangular waveform pulse voltage for continuously applied 32 times was performed at an interval of 2 sec and deviation per 15 min and an average value were obtained; and accordingly, the fluctuation shown in Equation (1) was calculated. At this time, a crest value of the rectangular wave voltage applied between the cathode electrode 2 and the gate electrode 5 was adjusted in advance so as to be 10 μA in the average value of current.

Table 4 shows a voltage necessary for obtaining the current of 10 μA. In addition, amplitude of fluctuation is shown.

TABLE 4

| | Condition I | Condition J | Condition K |
|---|---|---|---|
| Applied gate voltage | 38 | 40 | 45 |
| (V) necessary for | | | |
| obtaining amount of | | | |
| emitted electrons of | | | |
| 10 μA | | | |
| Fluctuation | 1.3% | 1.1% | 1.2% |

Aside from this, electron emission was tried by coating an Mo film of 20 nm thickness in place of forming the polycrystalline film of lanthanum boride; however, the amount of emitted electrons of 10 μA could not be obtained even the gate voltage was applied up to 60 V. This seems because the Mo work function is large as compared with the polycrystalline film of lanthanum boride of the conditions I to K shown in Table 4.

As shown in Table 3, in the conditions l to K, in the polycrystalline film of lanthanum boride having a film thickness equal to or less than 20 nm and a crystallite size equal to or more than 2.5 nm and equal to or less than 10.7 nm, a work function equal to or less than 3.0 eV is actualized. Then, as shown in Table 4, under a large electron emission, the entire fluctuation could be held to be equal to or less than 1.3%.

### Example 5

In the present Example, an electron emission device shown in FIG. 4 was manufactured using a polycrystalline film 18 having the same characteristics as the polycrystalline film 8 formed by the condition J of the Example 2.

In FIG. 4, a quartz substrate was used as a substrate 11; and a cathode electrode 12 and a gate electrode 15 were formed of TaN of 20 nm film thickness. A first insulating layer 14a is SiN and 500 nm in film thickness. A second insulating layer 14b is SiO₂ and 30 nm in film thickness. A side face 141 of the first insulating layer 14a was inclined by 80° with respect to the substrate 11. A conductive member 13 was formed of Mo by means of the electron beam evaporation method so as to be 15 nm in film thickness on the side face 141 of the first insulating layer 14a. At the same time, a conductive film 17 made of Mo was also formed on the gate electrode 15. At that time, the substrate 11 was inclined so as to be 20° in incident angle of Mo with respect to the side face of the first insulating layer 14a. The polycrystalline film 18 of lanthanum boride was the same, polycrystal line film of LaB₆ as the film formed by the condition J of the Example 2; and a film thickness thereof (thickness from the projection portion end of Mo) was set to 10 nm. In addition, a distance x shown in FIG. 9A was 10 nm, and a distance d was 5 nm.

When electron emission characteristics of the electron emission device 20 manufactured by the present Example was evaluated as in the electron emission device manufactured by the Example 4, extremely good characteristics could be obtained as in the Example 4.

### Example 6

In the present Example, as shown by the typical cross-sectional view in FIG. 6, an image display panel 100 was manufactured by means of electron emission devices 10 shown in the Example 4.

More specifically, electron emission devices 10 are arranged in a lattice shape of 5760 units horizontally by 1200 units vertically on a glass substrate 1 to form a rear plate 32. On the other hand, luminescent materials 23 are arranged so that the number of pixels becomes 1920 units horizontally by 1200 units vertically on a glass transparent substrate 22 to form a face plate 31. Incidentally, one pixel is composed of a luminescent material which takes on a red luminescent color, a luminescent material which takes on a green luminescent color, and a luminescent material which takes on a blue luminescent color. A black matrix serving as a black member 24 is provided between respective luminescent layers; and a metal back made of aluminum is provided on the luminescent material 23 and the black member 24 as an anode electrode 21.

An arrangement was made in a vacuum chamber in a state where a supporting frame 27 provided with joint members 28 made of indium is arranged between the rear plate 32 and the face plate 31, and the inside of the chamber is exhausted under vacuum while heating. After that, confirmation was made that the chamber reached a sufficient degree of vacuum, and the rear plate 32 and/or the face plate 31 were compressed in a direction so that the rear plate 32 and the face plate 31 are opposed while maintaining a heated state to joint the rear plate 32 and the face plate 31 via the supporting frame 27. With this method, the image display panel 100 was obtained.

When a drive circuit was connected to the image display panel 100 manufactured by the present Example and an image was displayed, a prolonged stable image with high luminance could be obtained at a low driving voltage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-225812, filed on Sep. 3, 2008, and Japanese Patent Application No. 2009-183719, filed on Aug. 6, 2009, which are hereby incorporated by reference herein in their entirely.

What is claimed is:

1. An electron emission device comprising a polycrystalline film of lanthanum boride,
wherein a size of a crystallite which composes the polycrystalline film is equal to or more than 2.5 nm and equal to or less than 100 nm.

2. An electron emission device according to claim 1,
wherein a film thickness of the polycrystalline film is equal to or less than 100 nm.

3. An electron emission device according to claim 1,
wherein a film thickness of the polycrystalline film is equal to or less than 20 nm.

4. An electron emission device according to claim 3,
wherein
a ratio I₍₁₀₀₎/I₍₁₁₀₎ between integrated intensity I₍₁₀₀₎ of (100) plane and integrated intensity I₍₁₁₀₎ of (110) plane of the polycrystalline film, observed by X-ray diffraction, is equal to or more than 0.54 and equal to or less than 2.8.

5. An electron emission device according to claim 1,
wherein a ratio I₍₁₀₀₎/I₍₁₁₀₎ between integrated intensity I₍₁₀₀₎ of (100) plane and integrated intensity I₍₁₁₀₎ of (110) plane of an area equal to or less than 20 nm thickness from surface of the polycrystalline film, observed by X-ray diffraction, is equal to or more than 0.54 and equal to or less than 2.8.

6. An electron emission device according to claim 1,
wherein a ratio of B to La of the lanthanum boride, is equal to or more than 6.0 and equal to or less than 6.7.

7. An electron emission device according to claim 1,
wherein a work, function of the polycrystalline film is equal to or less than 3.0 eV.

8. An electron emission device according to claim 1,
wherein the electron emission device comprises a cathode and a gate electrode disposed apart from the cathode,
the cathode has a projection portion; and
the polycrystalline film constitutes at least, a part of the projection portion.

9. An electron emission device according to claim 1,
wherein, the electron emission device comprises, an insulating layer having a top face and a side face continuing each other, a cathode, and a gate electrode disposed on the insulating layer apart from, the cathode,
the cathode has a projection portion located across the top face and the side face; and
the polycrystalline film constitutes at least, a part of the projection portion.

10. An image display panel comprising:
a rear plate including an electron emission device; and
a face plate including a luminescent material which emits light by being irradiated by an electron emitted from the electron emission device,
wherein the electron emission device is the electron emission device as set forth in claim 1.

11. An image display apparatus comprising:
an image display panel; and
a circuit which generates a signal that drives the image display panel on the basis of an inputted image signal,
wherein the image display panel is the image display panel as set forth in claim 10.

12. An information display apparatus comprising:
an image display apparatus; and
an apparatus which outputs an image signal to the image display apparatus on the basis of an inputted information signal,
wherein the image display apparatus is the image display apparatus as set forth in claim 11.
